(19) United States
(12) Patent Application Publication
(10) Pub. No.: US 2016/0249371 A1
(43) Pub. Date: Aug. 25, 2016

(54) TECHNIQUES FOR DYNAMIC SENSITIVITY CONTROL

(71) Applicant: QUALCOMM Incorporated, San Diego, CA (US)

(72) Inventors: Yan ZHOU, San Diego, CA (US); Gwendolyn Denise BARRIAC, Encinitas, CA (US); Simone MERLIN, San Diego, CA (US); George CHERIAN, San Diego, CA (US)

(21) Appl. No.: 15/144,261

(22) Filed: May 2, 2016

Related U.S. Application Data
(63) Continuation-in-part of application No. 14/981,713, filed on Dec. 28, 2015.
(60) Provisional application No. 62/157,402, filed on May 5, 2015.
(60) Provisional application No. 62/098,253, filed on Dec. 30, 2014.

(51) Int. Cl. H04W 72/08; H04W 74/00; H04W 74/08; H04W 72/04

(52) U.S. Cl. CPC H04W 72/085; H04W 72/048; H04W 74/008; H04W 74/08

(57) ABSTRACT

Various aspects are provided related to techniques for dynamic sensitivity control. Modification and enhancements to dynamic sensitivity control operations are described that address hidden node issues and provide fairer access to wireless stations located at the edge of coverage of an access point. Aspects of these modifications and enhancements can be combined to provide different variants of the dynamic sensitivity control operations.

### CROSS-REFERENCE TO RELATED APPLICATION(S)

This application claims the benefit of U.S. Provisional Application Ser. No. 62/157,402, entitled “TECHNIQUES FOR DYNAMIC SENSITIVITY CONTROL” and filed on May 5, 2015, which is expressly incorporated by reference herein in its entirety.

This application is also a Continuation-in-Part of U.S. Non-Provisional application Ser. No. 14/981,713, entitled “Adaptive EDCA Adjustment for Dynamic Sensitivity Control” filed Dec. 28, 2015, which further claims the benefit of U.S. Provisional Application Ser. No. 62/098,253 filed Dec. 30, 2014, which are expressly incorporated by reference herein in their entirety.

### BACKGROUND

The present disclosure relates generally to telecommunications, and specifically to techniques for dynamic sensitivity control.

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs.

Some WLAN network deployments may be dense (e.g., have a large number of STAs deployed with the coverage area of an AP), which may result in issues related to channel or medium reuse. One such issue may be the presence of hidden nodes (e.g., hidden STAs) within a BSS (e.g., in-BSS hidden nodes). To address this and other issues, and to be able to increase reuse within the BSS, a mechanism referred to as dynamic sensitivity control (DSC) has been generally proposed in which signal detection capabilities can be dynamically varied. This mechanism, however, may result in some degree of unfairness to those STAs in the BSS that are located at the edge of coverage of the AP because the improved sensitivity from the DSC operations may typically result in the edge STAs more easily deferring to other STAs and thus having reduced air time (e.g., access to the communications medium). Therefore, it is desirable to employ mechanisms or approaches that improve channel or medium reuse while also providing fair access to a wide range of STAs in a BSS.

### SUMMARY

In one aspect, a method for dynamically controlling signal sensitivity at a wireless station includes identifying a packet detection (PD) level based on a dynamic sensitivity control operation, determining a scaling factor based at least in part on the PD level, and adjusting at least one enhanced distributed channel access (EDCA) parameter based at least in part on the scaling factor.

In another aspect, an apparatus for dynamically controlling signal sensitivity at a wireless station includes means for identifying a PD level based on a dynamic sensitivity control operation, means for determining a scaling factor based at least in part on the PD level, and means for adjusting at least EDCA parameter based at least in part on the scaling factor.

In another aspect, an apparatus for dynamically controlling signal sensitivity at a wireless station is disclosed. The apparatus may include a processor and a memory coupled to the processor. The processor may be configured to execute the instructions to identify a PD level based on a dynamic sensitivity control operation, determine a scaling factor based at least in part on the PD level, and adjust at least one EDCA parameter based at least in part on the scaling factor.

In another aspect, a computer-readable medium storing executable code for dynamically controlling signal sensitivity at a wireless station is disclosed. The code be executable for identifying a PD level based on a dynamic sensitivity control operation, determining a scaling factor based at least in part on the PD level, and adjusting at least one EDCA parameter based at least in part on the scaling factor.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of a wireless local area network (WLAN) deployment;

FIG. 2 is a conceptual diagram illustrating an example of deferral regions for different STAs in a BSS;

FIGS. 3-7 are each a flow chart illustrating an example of aspects of a method related to modifications and variants of DSC operations;

FIG. 8 is a block diagram illustrating an example of a DSC component that supports modifications and variants of DSC operations in a wireless station; and

FIG. 9 is a block diagram illustrating an example of a DSC component that supports modifications and variants of DSC operations in an access point.

### DETAILED DESCRIPTION

As discussed above, some WLAN network deployments may be dense (e.g., have a large number of STAs deployed with the coverage area of an AP), which may result in issues related to channel or medium reuse. One such issue may be the presence of hidden nodes (e.g., hidden STAs) within a BSS (e.g., in-BSS hidden nodes). To address this and other issues, and to be able to increase reuse within the BSS, a mechanism referred to as dynamic sensitivity control (DSC) has been generally proposed in which signal detection capabilities can be dynamically varied. This mechanism, however, may result in some degree of unfairness to those STAs in the BSS that are located at the edge of coverage of the AP because the improved sensitivity from the DSC operations may typically result in the edge STAs more easily deferring to other STAs and thus having reduced air time (e.g., access to the communications medium).

In accordance with various aspects of the present disclosure, one or more enhanced distributed channel access (EDCA) parameters at an STA may be adjusted as a function of the packet detection (PD) level. The STA may adjust the EDCA parameters autonomously (e.g., without any external indication) or an Access Point (AP) may indicate to the STA to make the adjustments. The AP may transmit a mapping (e.g., table) of the PD and EDCA parameters, or may provide a formula, expression, or function and the inputs with which the STA may compute the PD and EDCA parameters.

One of the reasons for adjusting the EDCA parameters is because, as described below, those STAs with lower PD levels (e.g., STAs at the edge of the coverage area of the AP) will defer more than inner user STAs and will therefore have less air time. By utilizing more aggressive EDCA parameters, it is possible for the edge STAs to compensate for the lower PD levels and have more air time. This addresses, at least in part, the unfairness that results from having lower PD levels at the edge of the coverage area of the AP.

To adjust the EDCA parameters, the STA may first compute or determine the PD level based on the original DSC operations or based on any of the modifications of DSC operations described herein. The STA may then compute or determine a scaling factor (η) that represents the position of the PD level in the range between PDmin and PDmax. Once the scaling factor is determined, at least one EDCA parameter may be adjusted based on the scaling factor. The lower the value of the scaling factor, the more aggressive the EDCA parameter is once it is adjusted. In some examples, one or more EDCA parameters may include contention window minimum (CWMIN), maximum contention window (CWMAX) and an arbitration inter-frame spacing number (AIFSN), may be adjusted similarly to the adjustment described for CWMIN in the expression

Various concepts will be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details. In some instances, well known structures and components are shown in block diagram form in order to avoid obscuring the various concepts presented throughout this disclosure.

The present disclosure provides various aspects related to techniques for dynamic sensitivity control or DSC. Modification and enhancements to dynamic sensitivity control operations are described that address hidden node issues and provide for fairer access to wireless stations located at the edge of coverage of an access point. Aspects of these modifications and enhancements can be combined to provide different variants of the dynamic sensitivity control operations. The terms “original DSC” and “original dynamic sensitivity control” may refer to a previously proposed operation or function for determining the packet detection or deferral (PD) level at a wireless station. The terms “modified DSC” and “modified dynamic sensitivity control” may refer to the operations or functions being proposed in this disclosure that involve performing, or being able to perform, a determination of a detection level at a wireless station in a manner that is at least partially different from the original DSC operations.

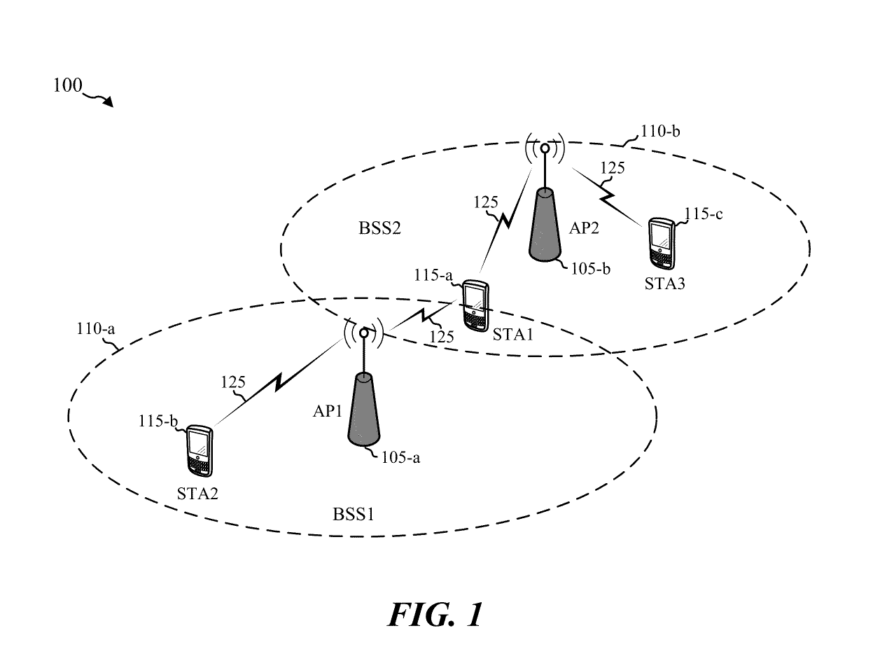

FIG. 1 is a wireless communications system 100 illustrating an example of a wireless local area network (WLAN) deployment in connection with various techniques described herein for modified dynamic sensitivity control operations. The WLAN may include one or more access points (APs) and one or more mobile stations (STAs) associated with a respective AP. In this example, there are two APs deployed: AP1 105-a in basic service set 1 (BSS1) and AP2 105-b in BSS2, which may referred to as an OBSS. AP1 105-a is shown having at least two associated STAs (STA1 115-a and STA2 115-b) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein for modified dynamic sensitivity control operations may be based on the WLAN deployment of FIG. 1 but need not be so limited.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications link 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects for performing operations based on modifications and enhancements to dynamic sensitivity control (e.g., to original dynamic sensitivity control) are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing operations based on modifications and enhancements to dynamic sensitivity control may be applicable to any suitable wireless network regardless of the coverage range and the wireless access protocols utilized.

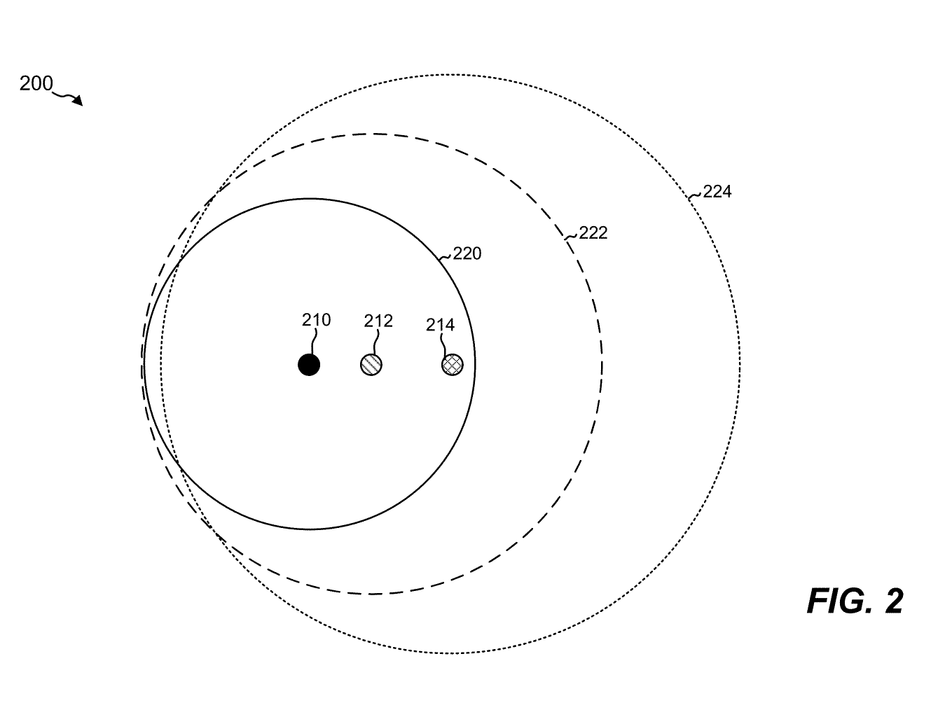

FIG. 2 is a conceptual diagram 200 illustrating an example of deferral regions for different STAs in a BSS. As noted above, dynamic sensitivity control operations have been proposed to increase reuse in WLAN deployments. In original dynamic sensitivity control (original DSC) operations, an STA (e.g., STA 115-a in FIG. 1) may set its packet detection or deferral (PD) level based on a signal strength metric (e.g., received signal strength indication or RSSI) from its associated AP (e.g., AP 105-a in FIG. 1). The expression used to determine the PD level is shown below:

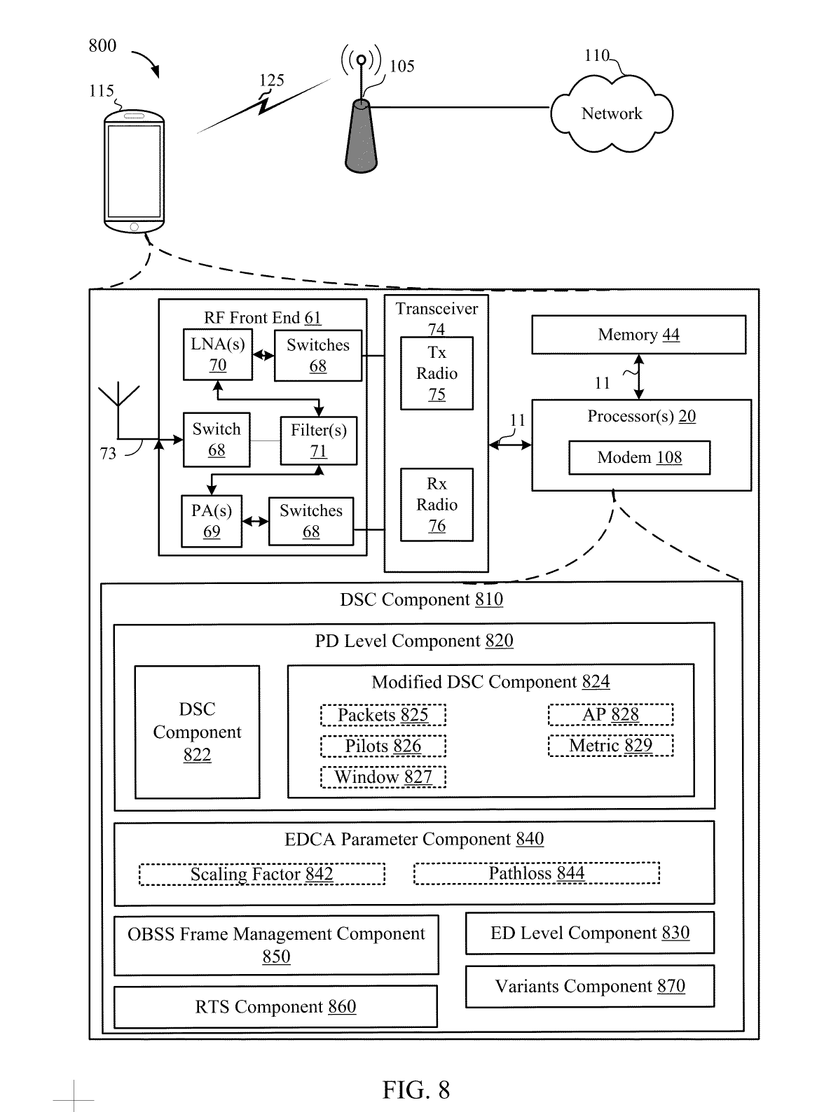

PD=max(min(RSSI−M,PDmax),PDmin), (1)

where RSSI is the signal strength metric measurement made from an AP beacon signal, M is a tunable margin, and PDmin and PDmax are the limits of the PD range. In one example, PDmin=−40 dBm, PDmax=−82 dBm, and M=10 or 20 dB. The expression (1) may be performed by, for example, a DSC component 822 in a PD level component 820 of a DSC component 810 shown in FIG. 8. The objective of the original DSC is to set the PD level in each STA such that in-BSS nodes (e.g., STAs within BSS1) can defer to each other. That is, when an STA detects a packet preamble and the RSSI of the packet preamble is greater than the PD level obtained from the original DSC expression, then the STA will defer to the node (e.g., STA) that sent the packet and will not try to access the medium to transmit its own packets or frames. When the STA detects a packet preamble and the RSSI of the packet preamble is less than the PD level obtained from the original DSC expression, then the STA can ignore the packet (e.g., can transmit its own packets or frames)

When the RSSI measured by the STA from the AP beacon signal is low, then the STA is likely to be far from the AP and to have a low PD level. By having a low PD level, an STA far from the AP (e.g., at the edge of the AP coverage area) can detect hidden nodes (e.g., non in-BSS hidden nodes) and avoid collisions with the hidden nodes. When the RSSI measured by the STA from the AP beacon signal is high, then the STA is likely to be an inner user STA (e.g., STA close to the AP) and to have a high PD level. By having a high PD level, inner user STAs have a higher channel or medium reuse because they tend not to defer to other STAs as much. In one example, two inner users (e.g., STAs with high PD levels) can transmit simultaneously for better reuse without either one interfering with the other.

Returning to FIG. 2, the conceptual diagram 200 shows an access point or AP 210 having a coverage area 220. The AP 210 may be an example of the AP 105-a in FIG. 1. Within the coverage area 220 there may be multiple STAs. In this example, there are two STAs 212 and 214 with the coverage area 220 of the AP 210. The STAs 212 and 214 may be examples of the STAs shown in FIG. 1. The STA 212, which is closer to the AP 210, has a smaller deferral region 222 (dashed line) than a deferral region 224 (dotted line) of the STA 214, which is farther away from the AP 210, almost at the edge of a cell coverage provided by the AP 210. One issue that arises when implementing the original DSC operations is that there may be an inherent unfairness in the way that different STAs are able to access the channel or medium. As illustrated by conceptual diagram 200, those STAs at the edge of the coverage area (e.g., the STA 214) of the AP 210 have a larger deferral region, and hence lower reuse and much reduced air time (e.g., access to the channel or medium), than the inner user STAs that are closer to the AP 210 (e.g., the STA 212). The modification and enhancements described herein to the original DSC operations may not only address the hidden node issue but may also improve overall system performance by increasing reuse from those STAs that may be located at the edge of the coverage of an AP.

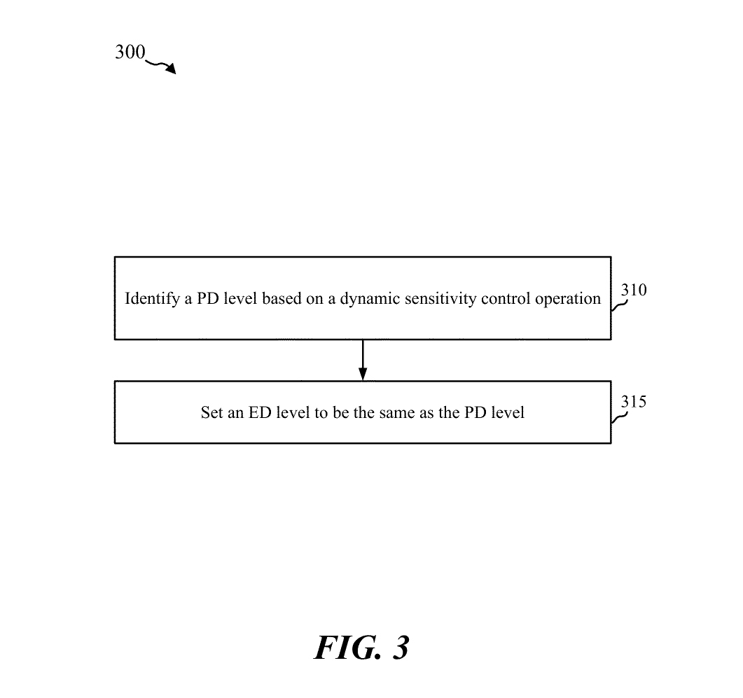

FIGS. 3-7 are each a flow chart illustrating an example of aspects of a method related to modifications and variants of DSC operations. In a first proposed modification, changes to the original DSC operations may be needed because by simply modifying the PD levels as shown in the expression (1) above, the issue of hidden nodes may not be fully addressed. That is, an STA may still miss (e.g., not properly decode) the preambles of packets sent from in-BSS STAs because of interference (e.g., low signal-to-noise-plus-interference-ratio or SINR), resulting in simultaneous transmissions when packet deferral would have been needed instead. Moreover, when an energy detection (ED) level is set to a lower level than the PD level, the functionality of the PD level is typically not helpful because it is effectively limited to that of the ED level. For example, when ED=−62 dBm, then the PD level is also capped at −62 dBm even when computed or determined to be a larger value. Energy detection may refer to the ability of a STA receiver to detect non-WLAN (e.g., non-Wi-Fi) energy in an operating channel and back off data transmission as a result.

In the first proposed modification, the PD level is obtained using expression (1) above (e.g., original DSC operations). Then, the ED level may be set based on the PD level. In one example, when the PD level is greater than an ED default level (e.g., PD>default ED), then the ED level is set to be the same as the PD level. In another example, the ED level is always set to be the same as the PD level.

FIG. 3 shows a flow chart illustrating an example of aspects of a method 300 related to the first proposed modification of the original DSC operations. At 310, a wireless station (e.g., STA 115-a in FIG. 1, wireless station 115 in FIG. 8) may identify a PD level based on a dynamic sensitivity control operation (e.g., original DSC operations). At 315, the wireless station may set an ED level to be the same as the PD level. The ED level may be set to be the same as the PD level in each instance or when the PD level is greater than an ED default level (e.g., −62 dBm). The DSC component 810 in FIG. 8 may include the PD level component 820, which may be configured to handle aspects of method 300 related to the PD level, and an ED level component 830, which may be configured to handle aspects of method 300 related to the ED level, including setting the ED level to the PD level.

In a second proposed modification of the original DSC operations, a detection level (e.g., PD level, the ED level, or both), may be determined based on a distance of a farthest STA in the BSS to the STA performing the DSC operations. The expression used to determine the detection level is shown below:

PD/ED=min_rssi_from_other_inBSS_STAs−margin, (2)

where the parameter min_rssi_from_other_inBSS_STAs is the minimum RSSI identified from other in-BSS STAs and the margin is a tunable margin (e.g., 3 dB). Here, in-BSS STAs may generally refer to any node in the same BSS, including the AP. The expression (2) may be used to set the PD level, the ED level, or both, at the STA. Moreover, the expression (2) may be associated with what is referred to in this disclosure as modified DSC operations.

There may be different ways in which the expression (2), and particularly the parameter min_rssi_from_other_inBSS_STAs, may be obtained. Below are described four possible options; however, other options may also be possible.

In a first option, the STA (e.g., STA 115-a in FIG. 1, wireless station 115 in FIG. 8) may identify all packets (see e.g., packets 825 in FIG. 8) that are received from other in-BSS STAs during a time window (see e.g., window 827 in FIG. 8) and may compute the minimum RSSI (see e.g., metric 829 in FIG. 8) from those packets. For example, the RSSI for each packet may be computed and the smallest or minimum RSSI from those computed may be identified. In this first option, the packets to be used may be identified based on the BSS color bits included in the preamble and on the uplink (UL) indicator, or based on the BSSID in the receiver address (RA) or the partial AID (PAID) field. For example, packets used to determine the minimum RSSI include packets with the same BSS color bits (e.g., same BSS) as those of the STA and a UL indicator that indicates that the packets are from STAs and not from APs. In another example, packets used to determine the minimum RSSI include packets with the same BSSID as that of STA (whether found in the RA or the PAID). In this first option, the RSSI (similar metrics may also be used) is measured on the whole BSS operation frequency band or in a portion of the frequency band (e.g., the primary channel).

In this first option, the minimum RSSI used to determine the parameter min_rssi_from_other_inBSS_STAs may be time averaged across two or more different time windows. Moreover, the PD/ED level computed using the expression (2) may be limited to a certain range. In one example, when the computed PD/ED level exceeds an upper limit of the range, the PD/ED level may be set to that upper limit. Similarly, in another example, when the computed PD/ED level is less than a lower limit of the range, the PD/ED level may be set to that lower limit.

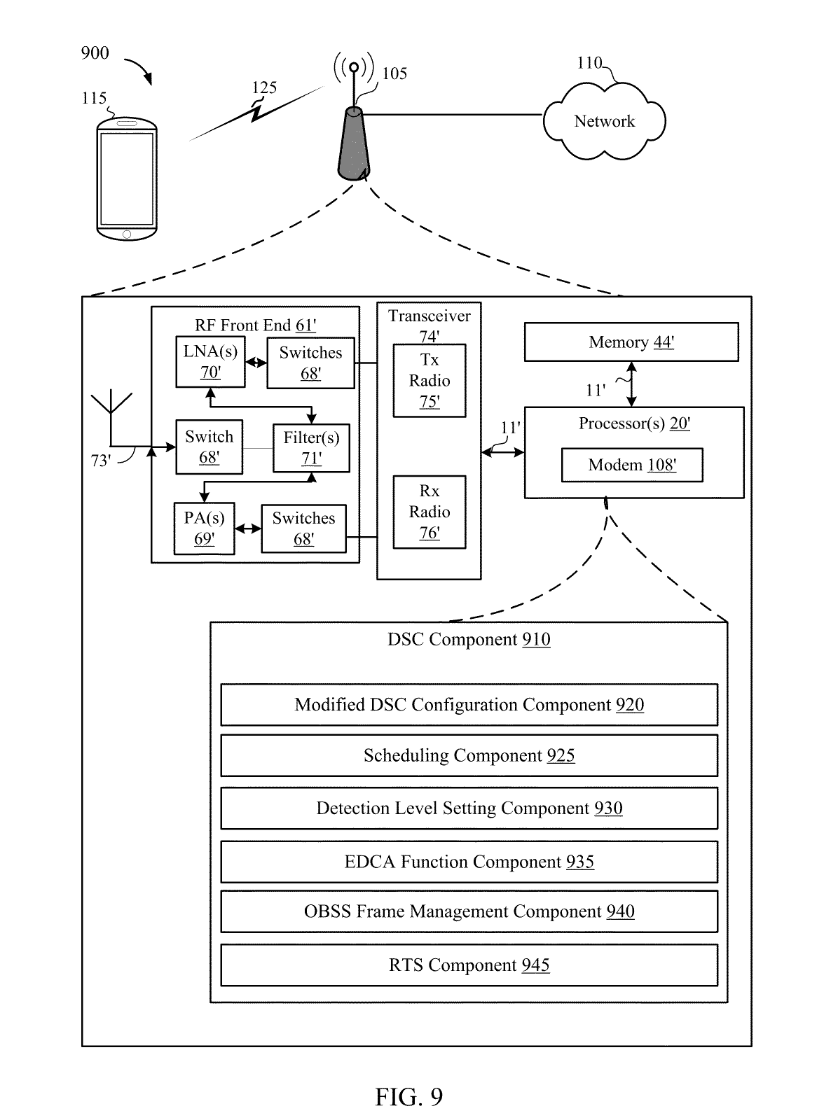

In this first option, an AP (e.g., AP 105-a in FIG. 1, the access point 105 in FIG. 9) may be used to configure the margin used in the expression (2), the measurement time window(s), time averaging weights applied to different time windows, and the PD/ED level range(s). In one example, the time averaging weights may be such that most recent time windows are weighted more heavily than older time windows when computing the minimum RSSI used to determine the parameter min_rssi_from_other_inBSS_STAs. In another example, a modified DSC configuration component 920 in a DSC component 910 of an access point 105 in FIG. 9 may be configured to provide the STA configuration described above.

In a second option to obtain a minimum RSSI, the AP (e.g., AP 105-a in FIG. 1, the access point 105 in FIG. 9) may request that the in-BSS STAs send pilot signals (e.g., known waveforms), from which the STA (e.g., STA 115-a in FIG. 1, wireless station 115 in FIG. 8) may compute the minimum RSSI and the PD/ED levels according to the expression (2). The STA need not know which STA transmitted the pilot signal that produces the minimum RSSI.

In this second option, the in-BSS STAs may send the pilot signals (sometimes referred simply as “pilots”) based on a scheduled resource (e.g., different time slots/sub-channels) or based on a carrier sense multiple access (CSMA) protocol, optionally in a scheduled time window.

In this second option, the AP may indicate a schedule to be used by the in-BSS STAs by indicating in a trigger frame (e.g., broadcasting a trigger frame) for immediate pilot signal sending or by indicating in a scheduling frame (e.g., broadcasting a beacon signal) for delayed pilot signal sending. In immediate pilot signal sending, the AP may indicate to one or more STAs to send the pilot signal based on the scheduled resource after receiving the trigger frame. In delayed pilot signal sending, the AP may indicate to one or more STAs to send the pilot signal based on the scheduled resource after a time duration (e.g., 30 milliseconds) since receiving the beacon signal. The indicated STAs and scheduled resource can be in the trigger frame or beacon signal, and can be different time slots/sub-channels or a common time window for CSMA-based transmissions. In one example, a scheduling component 925 in the DSC component 910 in FIG. 9 may be configured to provide the scheduling described above.

In this second option, the AP may select which in-BSS STAs are to send pilot signals to the STA to determine the minimum RSSI. For example, the AP may select those in-BSS STAs that are active (e.g., those indicating more data, buffered data, active traffic session, or having sent data transmissions within a certain number of seconds). In another example, the AP may select which in-BSS STAs are to send pilot signals to the STA based on those STAs that are likely farthest to other in-BSS STAs (e.g., those STAs with distance from the AP greater than a predetermined threshold or RSSI from the AP that is less than a predetermined threshold). In yet another example, the STAs may be selected based on both the activity of the STAs and the distance/RSSI from the AP.

In a third option to obtain a minimum RSSI, the STA (e.g., STA 115-a in FIG. 1, wireless station 115 in FIG. 8) may separately compute a first minimum RSSI from identified in-BSS UL packets (as described in the first option above) and a second minimum RSSI from the scheduled pilot signals (as described in the second option above). The STA may then determine the EP/ED level using the expression (2) based on the smallest of the first minimum RSSI and the second minimum RSSI.

In a fourth option to obtain a minimum RSSI, the AP (e.g., AP 105-a in FIG. 1, the access point 105 in FIG. 9) may determine the PD/ED level setting based on distance. For example, the AP may have STA location information based on GPS coordinates or some other type of positioning information. For each STA (e.g., STA 115-a in FIG. 1, wireless station 115 in FIG. 8), the AP computes or determines the distance of the farthest in-BSS STA to that STA, and based on this distance the AP then computes or determines the pathloss between the STA and its associated farthest STA. The AP may obtain the pathloss from a table (e.g., a computed 30 meter distance corresponds to a 70 dB pathloss), or by some other method (e.g., function or computation). The AP may further estimates RSSI as the transmit power of the farthest STA minus the pathloss. The AP may use this RSSI as the minimum RSSI for the expression (2), may compute or determine PD/ED level based on the minimum RSSI, and may send the PD/ED level to the respective STA. In one example, a detection level setting component 930 in the DSC component 910 in FIG. 9 may be configured to set the PD/ED level for an STA as described above. Note that in the above-described options, the minimum RSSI may be computed among all in-BSS nodes, including both STAs and AP.

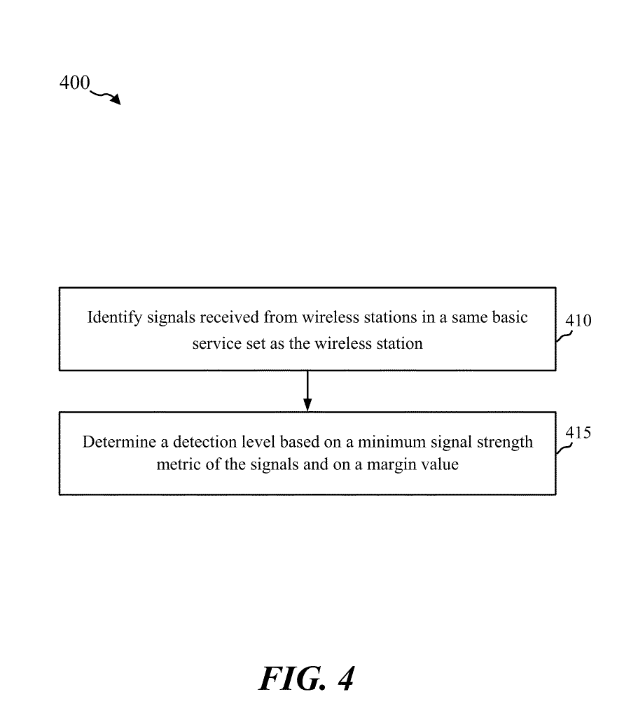

FIG. 4 shows a flow chart illustrating an example of aspects of a method 400 related to the second proposed modification of the original DSC operations. At 410, a wireless station (e.g., STA 115-a in FIG. 1, wireless station 115 in FIG. 8) may identify signals (e.g., signals including packets, pilot signals) received from wireless stations in a same basic service set (in-BSS) as the wireless station. At 315, a detection level (e.g., PD level, ED level, or both) may be determined based on a minimum signal strength metric (e.g., RSSI) of the signals and on a margin value (see e.g., margin in the expression (2)). A DSC component 810 in FIG. 8 may include the PD level component 820 and/or a modified DSC component 824 that may be configured to handle aspects of method 400 related to the PD level, and the ED level component 830 that may be configured to handle aspects of method 400 related to the ED level.

In a third proposed modification of the original DSC operations, one or more enhanced distributed channel access (EDCA) parameters at an STA (e.g., STA 115-a in FIG. 1, wireless station 115 in FIG. 8) may be adjusted as a function of the PD level (which may be determined based on the original DSC operations (expression (1)) or based on the modified DSC operations (expression (2)). The STA may adjust the EDCA parameters autonomously (e.g., without any external indication) or an AP (e.g., AP 105-a in FIG. 1, the access point 105 in FIG. 9) may indicate to the STA to make the adjustments. The AP may transmit a mapping (e.g., table) of the PD and EDCA parameters, or may provide a formula, expression, or function and the inputs with which the STA may compute the PD and EDCA parameters. In one example, an EDCA function component 935 in the DSC component 910 in FIG. 9 may be configured to provide the indication and other EDCA-related information to the STA.

One of the reasons for adjusting the EDCA parameters is because, as described above, those STAs with lower PD levels (e.g., STAs at the edge of the coverage area of the AP) will defer more than inner user STAs and will therefore have less air time. By utilizing more aggressive EDCA parameters, it is possible for the edge STAs to compensate for the lower PD levels and have more air time. This addresses, at least in part, the unfairness that results from having lower PD levels at the edge of the coverage area of the AP.

To adjust the EDCA parameters, the STA may first compute or determine the PD level based on the original DSC operations or based on any of the modifications of DSC operations described herein. The STA may then compute or determine a scaling factor (η) that represents the position of the PD level in the range between PDmin and PDmax. The scaling factor may be determined based on the following expression:

η=(PD−PDmin)/(PDmax−PDmin). (3)

Once the scaling factor is determined, at least one EDCA parameter may be adjusted based on the scaling factor. The lower the value of the scaling factor, the more aggressive the EDCA parameter is once it is adjusted. For example, a minimum contention window size (CWMIN) may be adjusted based on the following expression:

CWMIN=CWMIN min+(CWMIN max−CWMIN min)×η, (4)

where CWMIN min is the lower limit of CWMIN, CWMIN max is the upper limit of CWMIN, and η is the scaling factor as described in the expression (3) above. Based on the expression (4), it is clear that a higher η results in a larger minimum contention window. However, a lower η corresponds to a smaller minimum contention window and a more aggressive EDCA parameter. Other EDCA parameters, such a maximum contention window (CWMAX) and an arbitration inter-frame spacing number (AIFSN), may be adjusted similarly to the adjustment described for CWMIN in the expression (4).

For other EDCA parameters, such as transmission opportunity (TXOP), the adjustment may be based on the following expression:

TXOP=TXOP max−(TXOP max−TXOP min)×η, (5)

where TXOP min is the lower limit of TXOP, TXOP max is the upper limit of TXOP, and η is the scaling factor as described in the expression (3) above. Based on the expression (5), it is clear that a higher η results in a smaller transmission opportunity.

In another aspect of the third proposed modification of the original DSC operations, one or more EDCA parameters at an STA may be adjusted as a function of the ED level or an indicator of a distance between the STA and its associated AP. Such indicator may be a pathloss or signal strength metric (e.g., RSSI). In one example, the EDCA function component 935 in the DSC component 910 in FIG. 9 may be configured to provide at least some of this information to the STA. When a pathloss (PL) is considered, the scaling factor may be determined based on the following expression:

η=(PL−PLmin)/(PLmax−PLmin), (6)

where PLmin is the lower limit of PL, PLmax is the upper limit of PL, and η is the scaling factor. The η that results from the expression (6) may be used in the expressions (4) and (5) above in a manner similar to the η that results from the expression (3) above.

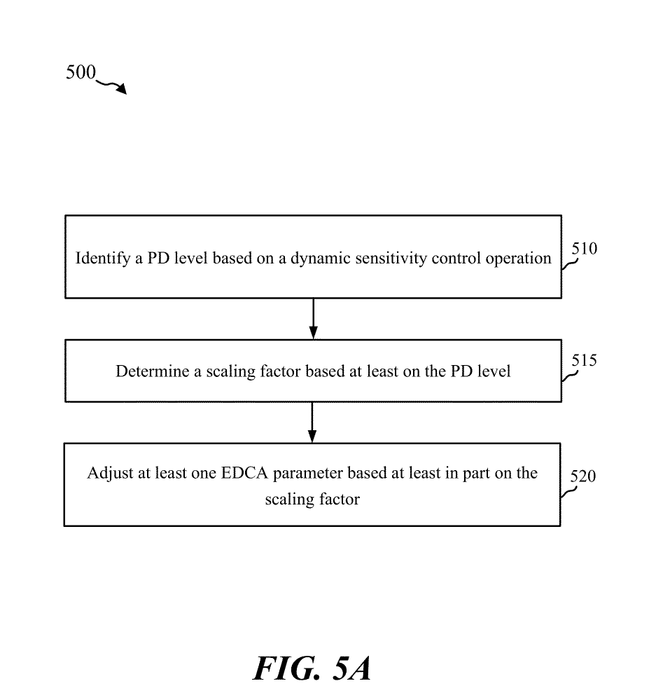

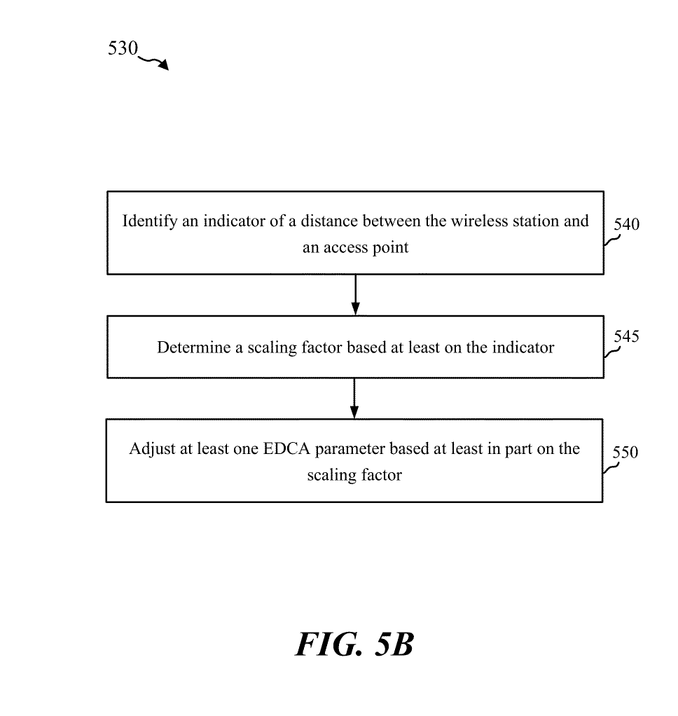

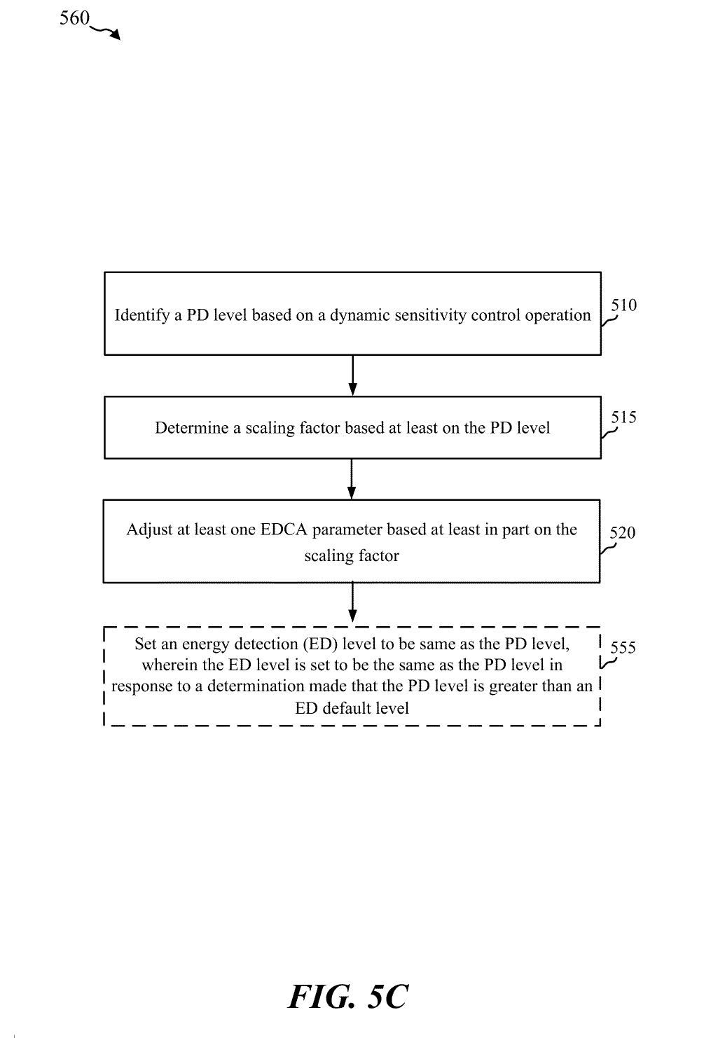

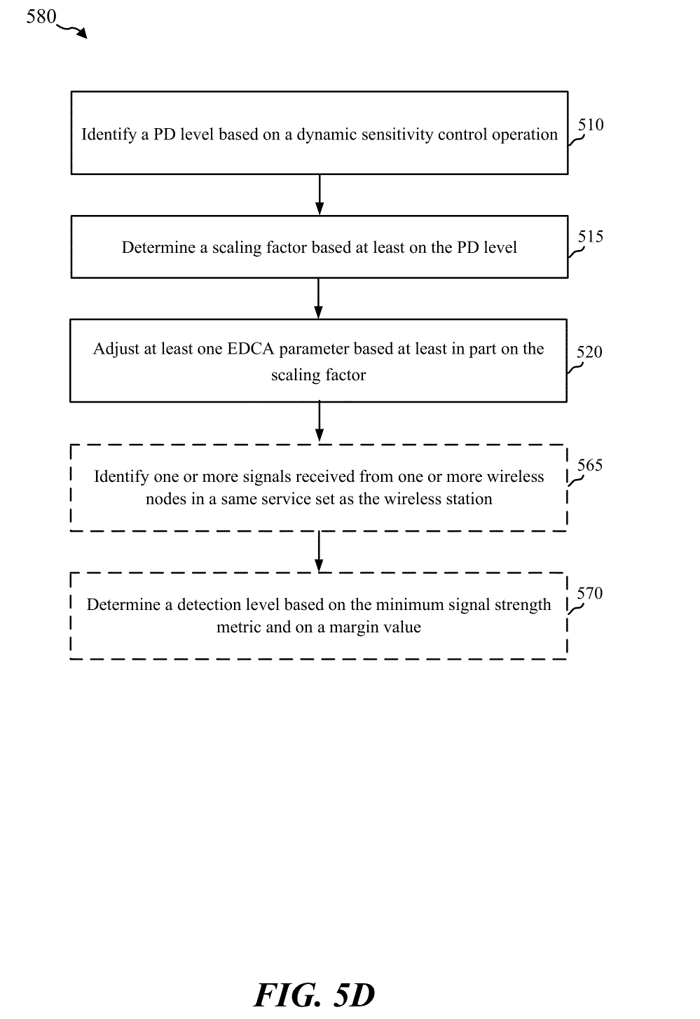

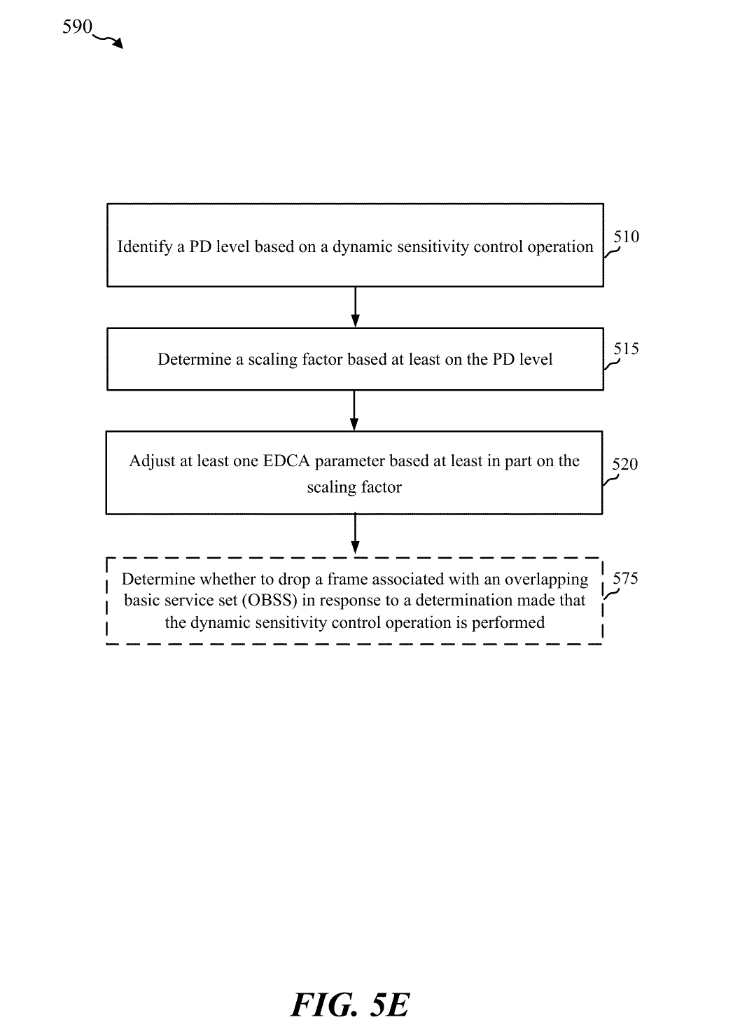

FIG. 5A shows a flow chart illustrating an example of aspects of a method 500 related to the third proposed modification of the original DSC operations. At 510, a wireless station (e.g., STA 115-a in FIG. 1, wireless station 115 in FIG. 8) may identify a PD level based on a dynamic sensitivity control operation (e.g., original DSC operations or modified DSC operations).

At 515, the wireless station may determine a scaling factor (e.g., the expression (3), scaling factor 842 in FIG. 8) based at least on the PD level. At 520, at least one EDCA parameter (e.g., CWMIN, CWMAX, AIFSN, TXOP) may be adjusted based at least in part on the scaling factor. A DSC component 810 in FIG. 8 may include an EDCA parameter component 840 that may be configured to handle aspects of method 500 related to the scaling factor and the adjustment of EDCA parameters.

FIG. 5B shows a flow chart illustrating an example of additional aspects of a method 530 related to the third proposed modification of the original DSC operations. At 540, a wireless station (e.g., STA 115-a in FIG. 1, wireless station 115 in FIG. 8) may identify an indicator of a distance between the wireless station and an access point (e.g., AP 105-a in FIG. 1, access point 105 in FIG. 9). The indicator may be pathloss (e.g., pathloss 844 in FIG. 8) or a signal strength metric (e.g., RSSI) between the wireless station and the access point. At 545, the wireless station may determine a scaling factor (e.g., the expression (6), scaling factor 842 in FIG. 8) based at least on the indicator. At 550, at least one EDCA parameter (e.g., CWMIN, CWMAX, AIFSN, TXOP) may be adjusted based at least in part on the scaling factor. A DSC component 810 in FIG. 8 may include the EDCA parameter component 840 that may be configured to handle aspects of method 530 related to the scaling factor and the adjustment of EDCA parameters.

In a fourth proposed modification of the original DSC operations, packets or frames associated with an OBSS (e.g., a BSS other than the BSS of the STA), may be dropped when using DSC operations (e.g., the original DSC operations or the modified DSC operations). This is in contrast with the default operation in which packets or frames from an OBSS are generally given deference (e.g., not dropped). The OBSS packets may be dropped by one or more nodes. For example, the OBSS packets may be dropped by an STA that supports DSC operations, by an AP associated with the STA, or by both.

In another aspect, the decision as to which OBSS packets or frames to drop may be based on the type of OBSS frame received by the node making the decision. There may be three types of OBSS frames: (1) Type 1—Frames defined by IEEE 802.11ax and carrying BSS color bits different from the color bits of the node making the decision; (2) Type 2—Legacy IEEE 802.11a/b/g/n/ac frames carrying BSSID different from the BSSID of the node making the decision; and (3) Type 3—Legacy IEEE 802.11a/b/g/n/ac frames for which BSSID cannot be determined. For Type 2 frames, the BSSID may be included in a request to send (RTS) receiver address (RA) for IEEE 802.11a and in an UL data frame partial AID (PAID) for IEEE 802.11ac. The decisions for each of these types may be different, and in some cases the decision may be binary (e.g., drop or not drop). The typical decision for Type 3 frames may be to always defer (not drop).

In another aspect, determining whether to drop a frame associated with an OBSS may include identifying the signal strength associated with the OBSS frame and making the determination based on the signal strength. For example, the OBSS frame may be dropped if its signal strength is below a predetermined threshold. In yet another aspect, determining whether to drop a frame associated with an OBSS may include estimating a caused interference on the intended receiver of the OBSS frame and making the determination based on the estimated caused interference. For example, the OBSS frame may be dropped if the estimated caused interference is below a predetermined threshold. The dropping node can estimate caused interference as the dropping node's transmit (Tx) power minus the path loss to the intended receiver of the OBSS frame. The path loss may be estimated based on RSSI (or some other signal strength metric) of previous received frames from the intended receiver, e.g. a clear to send (CTS) frame, which may also indicate the Tx power of the intended receiver to facilitate pathloss estimation.

In another aspect, an AP (e.g., AP 105-a in FIG. 1, access point 105 in FIG. 9) may inform the STAs that support DSC operations whether they are to drop OBSS frames, the different decisions they need to apply for the different types of frames, and/or other configurations for dropping decision, e.g. the threshold of signal strength and/or caused interference. The AP may provide this information as part of a beacon signal or some other management frame. In one example, an OBSS frame management component 940 in the DSC component 910 in FIG. 9 may be configured to identify and provide the appropriate OBSS packet drop information to one or more STAs.

FIG. 5C shows a flow chart illustrating an example of aspects of a method 560 related to another aspect of the third proposed modification of the original DSC operations. As noted above, at 510, a wireless station (e.g., STA 115-a in FIG. 1, wireless station 115 in FIG. 8) may identify a PD level based on a dynamic sensitivity control operation (e.g., original DSC operations or modified DSC operations).

At 515, the wireless station may determine a scaling factor (e.g., the expression (3), scaling factor 842 in FIG. 8) based at least on the PD level. At 520, at least one EDCA parameter (e.g., CWMIN, CWMAX, AIFSN, TXOP) may be adjusted based at least in part on the scaling factor. A DSC component 810 in FIG. 8 may include an EDCA parameter component 840 that may be configured to handle aspects of method 500 related to the scaling factor and the adjustment of EDCA parameters.

At 555, the wireless station may set an energy detection (ED) level to be same as the PD level. In some aspects, the ED level may be set to be the same as the PD level in response to a determination made that the PD level is greater than an ED default level. The DSC component 810 in FIG. 8 may include the PD level component 820, which may be configured to handle aspects of method 560 related to the PD level, and an ED level component 830, which may be configured to handle aspects of method 560 related to the ED level, including setting the ED level to the PD level.

FIG. 5D shows a flow chart illustrating an example of aspects of a method 580 related to another aspect of the third proposed modification of the original DSC operations. As noted above, at 510, a wireless station (e.g., STA 115-a in FIG. 1, wireless station 115 in FIG. 8) may identify a PD level based on a dynamic sensitivity control operation (e.g., original DSC operations or modified DSC operations).

At 515, the wireless station may determine a scaling factor (e.g., the expression (3), scaling factor 842 in FIG. 8) based at least on the PD level. At 520, at least one EDCA parameter (e.g., CWMIN, CWMAX, AIFSN, TXOP) may be adjusted based at least in part on the scaling factor. A DSC component 810 in FIG. 8 may include an EDCA parameter component 840 that may be configured to handle aspects of method 500 related to the scaling factor and the adjustment of EDCA parameters.

At 565, a wireless station (e.g., STA 115-a in FIG. 1, wireless station 115 in FIG. 8) may identify signals (e.g., signals including packets, pilot signals) received from wireless stations in a same basic service set (in-BSS) as the wireless station.

At 570, a detection level (e.g., PD level, ED level, or both) may be determined based on a minimum signal strength metric (e.g., RSSI) of the signals and on a margin value (see e.g., margin in the expression (2)). A DSC component 810 in FIG. 8 may include the PD level component 820 and/or a modified DSC component 824 that may be configured to handle aspects of method 580 related to the PD level, and the ED level component 830 that may be configured to handle aspects of method 580 related to the ED level.

FIG. 5E shows a flow chart illustrating an example of aspects of a method 590 related to another aspect of the third proposed modification of the original DSC operations. As noted above, at 510, a wireless station (e.g., STA 115-a in FIG. 1, wireless station 115 in FIG. 8) may identify a PD level based on a dynamic sensitivity control operation (e.g., original DSC operations or modified DSC operations).

At 515, the wireless station may determine a scaling factor (e.g., the expression (3), scaling factor 842 in FIG. 8) based at least on the PD level. At 520, at least one EDCA parameter (e.g., CWMIN, CWMAX, AIFSN, TXOP) may be adjusted based at least in part on the scaling factor. A DSC component 810 in FIG. 8 may include an EDCA parameter component 840 that may be configured to handle aspects of method 500 related to the scaling factor and the adjustment of EDCA parameters.

At 575, the wireless station may determine whether to drop a frame or packet associated with an OBSS when the dynamic sensitivity control operation is performed. The determination or decision of whether to drop the frame or packet associated with the OBSS may be based on a type of the frame or packet and/or on rules or decisions provided by an AP as to how to handle each type of frame or packet. The DSC component 810 in FIG. 8 may include an OBSS frame management component 850 that may be configured to handle aspects of method 600 related to deciding whether to drop OBSS packets from consideration.

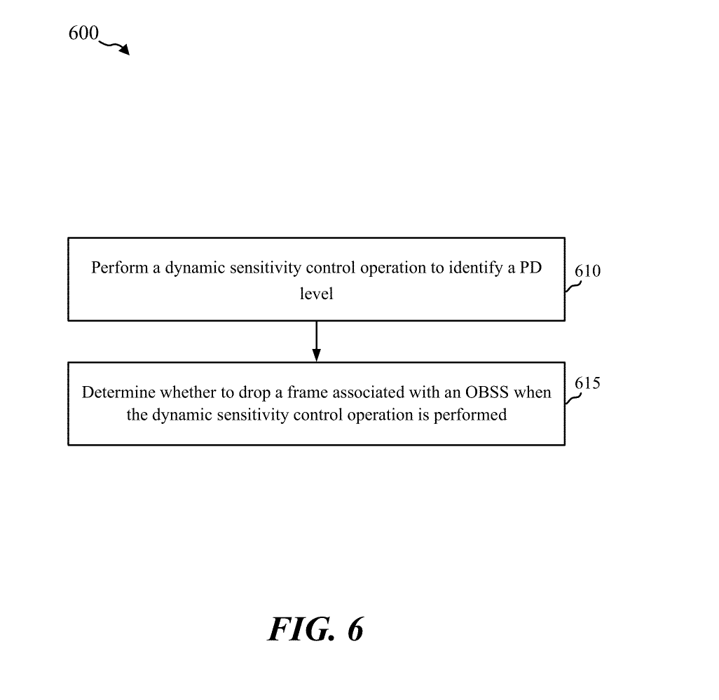

FIG. 6 shows a flow chart illustrating an example of aspects of a method 600 related to the fourth proposed modification of the original DSC operations. At 610, a wireless station (e.g., STA 115-a in FIG. 1, wireless station 115 in FIG. 8) may perform a dynamic sensitivity control operation to identify a PD level (e.g., original DSC operations or modified DSC operations. At 615, the wireless station may determine whether to drop a frame or packet associated with an OBSS when the dynamic sensitivity control operation is performed. The determination or decision of whether to drop the frame or packet associated with the OBSS may be based on a type of the frame or packet and/or on rules or decisions provided by an AP as to how to handle each type of frame or packet. The DSC component 810 in FIG. 8 may include an OBSS frame management component 850 that may be configured to handle aspects of method 600 related to deciding whether to drop OBSS packets from consideration.

In a fifth proposed modification of the original DSC operations, request to send (RTS) and/or CTS capabilities may be enabled for those STAs, or at least a selected subset of the STAs, that support DSC operations (e.g., original DSC operations, modified DSC operations). The motivation is to mitigate UL CSMA collisions without requiring the very low detection levels that result from simply applying the original DSC operations. Again, this is with the aim of providing more fairness (e.g., air time) to those STAs that are located at the edge of the coverage are of the AP (see e.g., STA 214 in FIG. 2).

In one aspect, an AP (e.g., AP 105-a in FIG. 1, access point 105 in FIG. 9) may send a message that includes an RTS enabling information element (IE) to control the enabling/disabling of RTS capabilities in selected STAs.

In another aspect, there may be different conditions that trigger the enabling of RTS capabilities. For example, when the STA's TXOP is greater than a predefined threshold (e.g., 4 milliseconds), or when a node's PD level, ED level, or both, are lower than a predetermined threshold (e.g., −62 dBm). In the latter case, the PD level, the ED level, or both, may be set to another predetermined threshold (e.g., −62 dBm), after the enabling of RTS capability. The STA may additionally drop OBSS packets, as described above. Moreover, in-BSS packets are to be deferred regardless of the PD/ED level. Thus, in some aspects, the wireless station may determine whether the PD level is below a predefined threshold and determine whether to enable RTS in response to the determination that the PD level is below the predefined threshold. In one or more examples, the wireless system may further enable the RTS for the transmitted frames in response to the determination to enable RTS.

In another aspect, the AP may specify, in the RTS enabling IE, the various criteria described above for enabling RTS capabilities, as well as the different thresholds. In one example, an RTS component 945 in the DSC component 910 in FIG. 9 may be configured to identify and provide the appropriate RTS enabling information to one or more STAs.

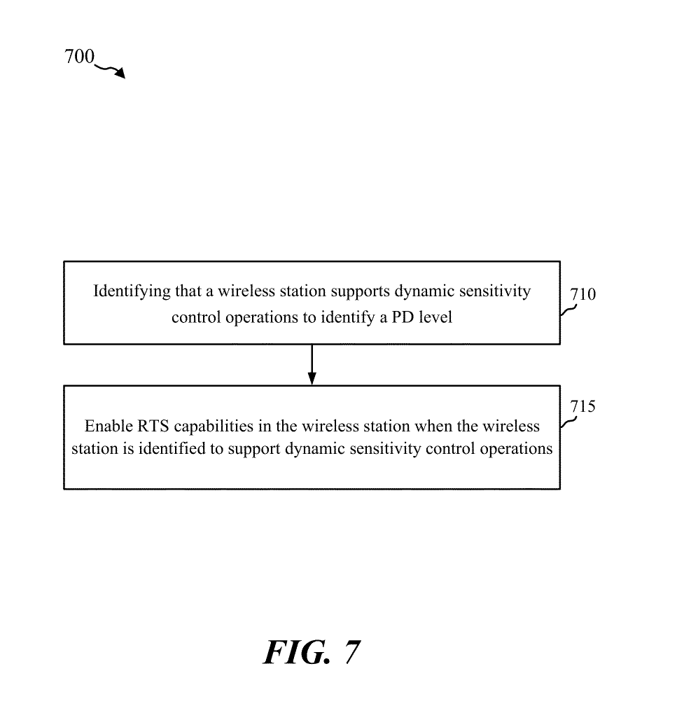

FIG. 7 shows a flow chart illustrating an example of aspects of a method 700 related to the fifth proposed modification of the original DSC operations. At 710, it is identified that a wireless station (e.g., STA 115-a in FIG. 1, wireless station 115 in FIG. 8) supports dynamic sensitivity control operations to identify a PD level. At 715, RTS capabilities are enabled in the wireless station when the wireless station is identified to support dynamic sensitivity control operations. A DSC component 810 in FIG. 8 may include an RTS component 860 that may be configured to handle aspects of method 700 related to enabling RTS capabilities.

With respect to the various modifications and enhancements to the original DSC operations described, there may be different variants or combinations that may prove helpful in addressing the hidden node and fairness issues for channel or medium reuse in WLAN deployments. A first variant or combination may include having the original DSC operations in addition to setting the ED level to be the same as the PD level when the PD level is greater than an ED default level (e.g., −62 dBm). A second variant or combination may include having the original DSC operations in addition to setting the ED level to be the same as the PD level in all instances. A third variant or combination may include the second variant as well as aspects of dropping of OBSS packets as described above with respect to the fourth modification proposal and FIG. 6. A fourth variant or combination may include the third variant as well as aspects of the adjustment or adaptation of EDCA parameters as described above with respect to the third modification proposal and FIGS. 5A and 5B. A fifth variant or combination may include the fourth variant as well as aspects of the enablement of RTS capabilities as described above with respect to the fifth modification proposal and FIG. 7.

The different variants or combinations described above may be configured, operated, managed, or otherwise handled by a variants component 870 in the DSC component 810 in FIG. 8.

Referring to FIG. 8, in an aspect, a wireless communication system 800 includes a STA 115 in communication coverage of at least one AP 105. The wireless communication system 800 may be an example of wireless communications system 100 described with reference to FIG. 1 In some examples, the STA 115 and/or the AP 105 may be an example of STA 115 and AP 105 described with reference to FIG. 1.

In an aspect, the STA 115 may include one or more processors 20 that may operate in combination with DSC component 810 to perform the functions, methodologies or methods presented in the present disclosure. The one or more processors 20 may include a modem 108 that uses one or more modem processors. The various functions related to the DSC component 810 may be included in modem 108 and/or processor 20 and, in an aspect, can be executed by a single processor, while in other aspects, different ones of the functions may be executed by a combination of two or more different processors. For example, in an aspect, the one or more processors 20 may include any one or any combination of a modem processor, or a baseband processor, or a digital signal processor, or a transmit processor, or a transceiver processor associated with transceiver 74, or a system-on-chip (SoC). In particular, the one or more processors 20 may execute functions and components included in the DSC component 810.

As described above, the DSC component 810 includes the PD level component 820 with the DSC component 922 and the modified DSC component 824. The DSC component 810 may also include the ED level component 830, the EDCA parameter component 840, the OBSS frame management component 850, the RTS component 860, and the variants component 870.

The PD level component 820 and the ED level component 830 may be configured to handle STA-related aspects of each of the modification proposals and variants described above as well as in FIGS. 2-7. The EDCA parameter component 840 may be configured to handle STA-related aspects of the third modification proposal described above as well as in FIGS. 5A and 5B. The OBSS frame management component 850 may be configured to handle STA-related aspects of the fourth modification proposal described above as well as in FIG. 6. The RTS component 860 may be configured to handle STA-related aspects of the fifth modification proposal described above as well as in FIG. 7. The variants component 870 may be configured to handle STA-related aspects of the different variants or combinations of the modification proposals described above.

In some examples, the DSC component 810 and each of the sub-components may comprise hardware, firmware, and/or software and may be configured to execute code or perform instructions stored in a memory (e.g., a computer-readable storage medium). Moreover, in an aspect, STA 115 may include RF front end 61 and transceiver 74 for receiving and transmitting radio transmissions, for example, via communications link 125 transmitted by AP 105. For example, transceiver 74 may receive a packet transmitted by the AP 105. STA 115, upon receipt of an entire message, may decode the message and perform a cyclic redundancy check (CRC) to determine whether the packet was received correctly. For example, transceiver 74 may communicate with modem 108 to transmit messages generated by DSC component 810 and to receive messages and forward them to the DSC component 810.

RF front end 61 may be connected to one or more antennas 73 and can include one or more switches 68, one or more amplifiers (e.g., power amplifiers (PAs) 69 and/or low-noise amplifiers 70), and one or more filters 71 for transmitting and receiving RF signals on the uplink channels and downlink channels. In an aspect, components of RF front end 61 can connect with transceiver 74. Transceiver 74 may connect to one or more modems 108 and processor 20.

Transceiver 74 may be configured to transmit (e.g., via transmitter radio 75) and receive (e.g., via receiver radio 76) and wireless signals through antennas 73 via RF front end 61. In an aspect, transceiver may be tuned to operate at specified frequencies such that STA 115 can communicate with, for example, AP 105. In an aspect, for example, modem 108 can configure the transceiver 74 to operate at a specified frequency and power level based on the UE configuration of the STA 115 and communication protocol used by modem.

STA 115 may further include a memory 44, such as for storing data used herein and/or local versions of applications or DSC component 810 and/or one or more of its subcomponents being executed by processor 20. Memory 44 can include any type of computer-readable medium usable by a computer or processor 20, such as random access memory (RAM), read only memory (ROM), tapes, magnetic discs, optical discs, volatile memory, non-volatile memory, and any combination thereof. In an aspect, for example, memory 44 may be a computer-readable storage medium that stores one or more computer-executable codes defining DSC component 810 and/or one or more of its subcomponents. Additionally or alternatively, the STA 115 may include a bus 11 for coupling the RF front end 61, transceiver 74, memory 44 and processor 20 and to exchange signaling information between each of the components and/or subcomponents of the STA 115.

Referring to FIG. 9, in an aspect, a wireless communication system 900 includes a STA 115 in communication coverage of at least one AP 105. The wireless communication system 900 may be an example of wireless communications system 100 described with reference to FIG. 1 In some examples, the STA 115 and/or the AP 105 may be an example of STA 115 and AP 105 described with reference to FIG. 1.

In an aspect, the AP 105 may include one or more processors 20′ that may operate in combination with DSC component 910 to perform the functions, methodologies or methods presented in the present disclosure. The one or more processors 20′ may include a modem 108′ that uses one or more modem processors. The various functions related to the DSC component 910 may be included in modem 108′ and/or processor 20′ and, in an aspect, can be executed by a single processor, while in other aspects, different ones of the functions may be executed by a combination of two or more different processors. For example, in an aspect, the one or more processors 20′ may include any one or any combination of a modem processor, or a baseband processor, or a digital signal processor, or a transmit processor, or a transceiver processor associated with transceiver 74′, or a system-on-chip (SoC). In particular, the one or more processors 20′ may execute functions and components included in the DSC component 910.

The wireless communication system 900 illustrates an example of the DSC component 910 that supports modifications and variants or variations of DSC operations in the access point 105 (e.g., AP 105-a in FIG. 1). The DSC component 910, or a subset of the functionality of the DSC component 910, may be implemented or performed by a processor by executing one or more instructions stored in a computer-readable medium/memory. As described above, the DSC component 910 includes the modified DSC configuration component 920 configured to handle AP-related aspects of STA configuration operations for the modification proposals, the scheduling component 925 configured to handle AP-related aspects of scheduling for the modification proposals, the detection level setting component 930 configured to handle AP-related aspects of setting detection levels for the modification proposals, the EDCA function component 935 configured to handle AP-related aspects of the EDCA adjustments for the modification proposals, the OBSS frame management component 940 configured to handle AP-related aspects of dropping OBSS frames for the modification proposals, and the RTS component 945 configured to handle AP-related aspects for the enabling of RTS capabilities for the modification proposals.

In some examples, the DSC component 910 and each of the sub-components may comprise hardware, firmware, and/or software and may be configured to execute code or perform instructions stored in a memory (e.g., a computer-readable storage medium). Moreover, in an aspect, AP 105 may include RF front end 61′ and transceiver 74′ for receiving and transmitting radio transmissions, for example via communications link 125. For example, transceiver 74′ may receive a packet transmitted by the AP 105. STA 115, upon receipt of an entire message, may decode the message and perform a cyclic redundancy check (CRC) to determine whether the packet was received correctly. For example, transceiver 74′ may communicate with modem 108 to transmit messages generated by DSC component 910 and to receive messages and forward them to the DSC component 910.

RF front end 61′ may be connected to one or more antennas 73′ and can include one or more switches 68′, one or more amplifiers (e.g., power amplifiers (PAs) 69′ and/or low-noise amplifiers 70′), and one or more filters 71′ for transmitting and receiving RF signals on the uplink channels and downlink channels. In an aspect, components of RF front end 61′ can connect with transceiver 74′. Transceiver 74′ may connect to one or more modems 108 and processor 20′.

Transceiver 74′ may be configured to transmit (e.g., via transmitter radio 75′) and receive (e.g., via receiver radio 76′) and wireless signals through antennas 73′ via RF front end 61′. In an aspect, transceiver may be tuned to operate at specified frequencies such that AP 105 can communicate with, for example, STA 115. In an aspect, for example, modem 108 can configure the transceiver 74′ to operate at a specified frequency and power level based on the AP configuration of the AP 105 and communication protocol used by modem.

AP 105 may further include a memory 44′, such as for storing data used herein and/or local versions of applications or DSC component 910 and/or one or more of its subcomponents being executed by processor 20′. Memory 44′ can include any type of computer-readable medium usable by a computer or processor 20′, such as random access memory (RAM), read only memory (ROM), tapes, magnetic discs, optical discs, volatile memory, non-volatile memory, and any combination thereof. In an aspect, for example, memory 44′ may be a computer-readable storage medium that stores one or more computer-executable codes defining DSC component 910 and/or one or more of its subcomponents. Additionally or alternatively, the AP 105 may include a bus 11 for coupling the RF front end 61′, transceiver 74′, memory 44′ and processor 20′ and to exchange signaling information between each of the components and/or subcomponents of the AP 105.

The apparatus and methods have been described in the detailed description and illustrated in the accompanying drawings by various elements comprising blocks, modules, components, circuits, steps, processes, algorithms, and the like. These elements, or any portion thereof, either alone or in combinations with other elements and/or functions, may be implemented using electronic hardware, computer software, or any combination thereof. Whether such elements are implemented as hardware or software depends upon the particular application and design constraints imposed on the overall system. In an aspect, the term “component” as used herein may be one of the parts that make up a system and may be divided into other components.

By way of example, an element, or any portion of an element, or any combination of elements may be implemented with a “processing system” that includes one or more processors. A processor may include a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on transitory or non-transitory computer-readable medium. A non-transitory computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), static RAM (SRAM), dynamic RAM (DRAM), synchronous dynamic RAM (SDRAM); double date rate RAM (DDRAM), read only memory (ROM), programmable ROM (PROM), erasable PROM (EPROM), electrically erasable PROM (EEPROM), a general register, or any other suitable non-transitory medium for storing software.

The various interconnections within a processing system may be shown as buses or as single signal lines. Each of the buses may alternatively be a single signal line, and each of the single signal lines may alternatively be buses, and a single line or bus might represent any one or more of a myriad of physical or logical mechanisms for communication between elements. Any of the signals provided over various buses described herein may be time-multiplexed with other signals and provided over one or more common buses.

The various aspects of this disclosure are provided to enable one of ordinary skill in the art to practice the present invention. Various modifications to examples of implementations presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the examples of implementations described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112 (f), unless the element is expressly recited using the phrase “means for” or, in the case of a method claim, the element is recited using the phrase “step for.”

What is claimed is:

1. A method for dynamically controlling signal sensitivity at a wireless station, comprising:
identifying a packet detection (PD) level based on a dynamic sensitivity control operation;
determining a scaling factor based at least in part on the PD level; and
adjusting at least one enhanced distributed channel access (EDCA) parameter based at least in part on the scaling factor.

2. The method of claim 1, wherein the scaling factor is further based on a minimum value of the PD level and a maximum value of the PD level.

3. The method of claim 1, wherein the at least one EDCA parameter at the wireless station is adjusted based on an indicator of a distance between the wireless station and an access point (AP) associated with the wireless station, wherein the indicator includes the path loss between the wireless station and the AP.

4. The method of claim 1, wherein the at least one EDCA parameter includes one or more of a contention window minimum (CWMIN), a contention window maximum (CWMAX), a transmission opportunity (TXOP), and an arbitration inter-frame spacing number (AIFSN).

5. The method of claim 1, further comprising setting an energy detection (ED) level to be same as the PD level.

6. The method of claim 5, further comprising:
determining whether the PD level is greater than an default ED level; and
wherein the ED level is set to be the same as the PD level when the determination is made that the PD level is greater than the default ED level.

7. The method of claim 1, further comprising:
identifying one or more signals received from one or more wireless nodes in a same basic service set as the wireless station;
determining a minimum signal strength metric of the one or more signals; and
determining a detection level based on the minimum signal strength metric and on a margin value, wherein the detection level includes PD level and energy detection (ED) level.

8. The method of claim 1, further comprising:
determining whether the dynamic sensitivity control operation is performed;
determining whether to drop a frame associated with an overlapping basic service set (OBSS) in response to a determination made that the dynamic sensitivity control operation is performed; and
dropping the frame associated with the OBSS in response to the determination to drop the frame.

9. The method of claim 1, further comprising:
determining whether the PD level is below a predefined threshold;
determining whether to enable RTS in response to the determination that the PD level is below the predefined threshold; and
enabling RTS for the transmitted frames in response to the determination to enable RTS.

10. An apparatus for dynamically controlling signal sensitivity at a wireless station, comprising:
means for identifying a packet detection (PD) level based on a dynamic sensitivity control operation;
means for determining a scaling factor based at least in part on the PD level; and
means for adjusting at least one enhanced distributed channel access (EDCA) parameter based at least in part on the scaling factor.

11. The apparatus of claim 10, wherein the scaling factor is further based on a minimum value of the PD level and a maximum value of the PD level.

12. The apparatus of claim 11, wherein the at least one EDCA parameter at the wireless station are adjusted based on an indicator of a distance between the wireless station and an access point (AP) associated with the wireless station, wherein the indicator includes the path loss between the wireless station and the AP.

13. The apparatus of claim 10, wherein the at least one EDCA parameter includes one or more of a contention window minimum (CWMIN), a contention window maximum (CWMAX), a transmission opportunity (TXOP), and an arbitration inter-frame spacing number (AIFSN).

14. The apparatus of claim 10, further comprising means for setting an energy detection (ED) level to be same as the PD level.

15. The apparatus of claim 14, further comprising:
means for determining whether the PD level is greater than an ED default level; and
wherein the ED level is set to be the same as the PD level when the determination is made that the PD level is greater than the ED default level.

16. The apparatus of claim 10, further comprising:
means for identifying one or more signals received from one or more wireless nodes in a same service set as the wireless station;
means for determining a minimum signal strength metric of the one or more signals; and
means for determining a detection level based on the minimum signal strength metric and on a margin value, wherein the detection level includes PD level and energy detection (ED) level.

17. The apparatus of claim 10, further comprising:
means for determining whether the dynamic sensitivity control operation is performed;
means for determining whether to drop a frame associated with an overlapping basic service set (OBSS) in response to a determination made that the dynamic sensitivity control operation is performed; and
means for dropping the frame associated with the OBSS in response to the determination to drop the frame.

18. The apparatus of claim 10, further comprising:
means for determining whether the PD level is below a predefined threshold;
means for determining whether to enable RTS in response to the determination that the PD level is below the predefined threshold; and
means for enabling RTS for the transmitted frames in response to the determination to enable RTS.

19. An apparatus for dynamically controlling signal sensitivity at a wireless station, comprising:
a memory configured to store instructions; and
a processor coupled to the memory, wherein the processor is configured to execute the instructions to:
identify a packet detection (PD) level based at least in part on a dynamic sensitivity control operation;
determine a scaling factor based at least on the PD level; and
adjust at least one enhanced distributed channel access (EDCA) parameter based at least in part on the scaling factor.

20. The apparatus of claim 19, wherein the scaling factor is further based on a minimum value of the PD level and a maximum value of the PD level.

21. The apparatus of claim 19, wherein the at least one EDCA parameter at the wireless station are adjusted based on an indicator of a distance between the wireless station and an access point (AP) associated with the wireless station, wherein the indicator includes the path loss between the wireless station and the AP.

22. The apparatus of claim 19, wherein the at least one EDCA parameter includes one or more of a contention window minimum (CWMIN), a contention window maximum (CWMAX), a transmission opportunity (TXOP), and an arbitration inter-frame spacing number (AIFSN).

23. The apparatus of claim 19, wherein the processor is further configured to execute the instructions to set an energy detection (ED) level to be same as the PD level.

24. The apparatus of claim 23, wherein the processor is further configured to execute the instructions to:
determine whether the PD level is greater than an ED default level; and
wherein the ED level is set to be the same as the PD level when the determination is made that the PD level is greater than the ED default level.

25. The apparatus of claim 19, wherein the processor is further configured to execute the instructions to:
identify one or more signals received from one or more wireless nodes in a same service set as the wireless station;
determine a minimum signal strength metric of the one or more signals; and
determine a detection level based on the minimum signal strength metric and on a margin value, wherein the detection level includes PD level and energy detection (ED) level.

26. The apparatus of claim 19, wherein the processor is further configured to execute the instructions to:
determine whether the dynamic sensitivity control operation is performed;
determine whether to drop a frame associated with an overlapping basic service set (OBSS) in response to a determination made that the dynamic sensitivity control operation is performed; and
drop the frame associated with the OBSS in response to the determination to drop the frame.

27. The apparatus of claim 19, wherein the processor is further configured to execute the instructions to:
determine whether the PD level is below a predefined threshold;
determine whether to enable RTS in response to the determination that the PD level is below the predefined threshold; and
enable RTS for the transmitted frames in response to the determination to enable RTS.

28. A computer-readable medium storing executable code for dynamically controlling signal sensitivity at a wireless station, comprising:
code for identifying a packet detection (PD) level based on a dynamic sensitivity control operation;
code for determining a scaling factor based at least on the PD level; and
code for adjusting at least one enhanced distributed channel access (EDCA) parameter based at least in part on the scaling factor.

29. The computer-readable medium of claim 28, wherein the scaling factor is further based on a minimum value of the PD level and a maximum value of the PD level.

30. The computer-readable medium of claim 28, wherein the at least one EDCA parameter at the wireless station is adjusted based on an indicator of a distance between the wireless station and an access point (AP) associated with the wireless station, wherein the indicator includes the path loss between the wireless station and the AP.
